(19) United States
(12) Patent Application Publication
(10) Pub. No.: US 2024/0322270 A1
(43) Pub. Date: Sep. 26, 2024

(54) BATTERY SYSTEM

(71) Applicant: LG ENERGY SOLUTION, LTD., Seoul (KR)

(72) Inventor: Sunwoo YOON, Daejeon (KR)

(73) Assignee: LG ENERGY SOLUTION, LTD., Seoul (KR)

(21) Appl. No.: 18/563,802

(22) PCT Filed: Nov. 7, 2022
(86) PCT No.: PCT/KR2022/017371

§ 371 Date: Nov. 22, 2023

(30) Foreign Application Priority Data
Nov. 8, 2021 (KR) 10-2021-0152521

(51) Int. Cl. H01M 10/42; H02J 7/00

(52) U.S. Cl. CPC H01M 10/4264; H02J 7/0013; H02J 7/0047; H01M 2010/4271; H02J 2207/10

(57) ABSTRACT

A battery system includes a plurality of battery packs, each of the plurality of battery packs including a plurality of battery cells, a plurality of slave battery management systems (BMSs) managing the plurality of battery packs, each of the plurality of BMSs including a battery monitoring integrated circuit (BMIC), and a relay turned on when the BMIC operates, a plurality of first resistors between both ends of a power source, a plurality of second resistors, a third resistor connected between the power source and the plurality of first resistors, and a master BMS determining positions and a number of BMICs operating among the plurality of BMICs based on a sensing voltage obtained by dividing a voltage of the power source by at least one of the third resistor, the plurality of first resistors, and the plurality of second resistors.

### CROSS-REFERENCE TO RELATED APPLICATIONS

This application claims priority to and the benefit of Korean Patent Application No. 10-2021-0152521 filed in the Korean Intellectual Property Office on Nov. 8, 2021, the entire contents of which are incorporated herein by reference.

### TECHNICAL FIELD

The present disclosure relates to a battery system.

### BACKGROUND ART

When an insulated communication method between a master battery management system (BMS) and a slave BMS is applied, as a method of diagnosing whether a battery monitoring integrated circuit (BMIC) monitoring a plurality of battery cells connected to the slave BMS is normal, whether communication is possible has been used. When there is no response to a periodic communication from the BMIC, the corresponding BMIC may be transitioned to a sleep state by a watchdog (e.g., watchdog timer, etc.). After transitioning to the sleep state, there is no method of checking whether unintentional current consumption due to malfunction, burnout, or noise occurs in the BMIC.

### DISCLOSURE

### Technical Problem

The present disclosure has been made in an effort to provide a battery system having advantages of diagnosing whether a plurality of BMICs constituting the battery system are normally operated.

### Technical Solution

A battery system according to a feature of the invention includes a plurality of battery packs, each of the plurality of battery packs including a plurality of battery cells; a plurality of slave battery management systems (BMSs), each slave BMS managing a respective one of the plurality of battery packs and including a battery monitoring integrated circuit (BMIC) connected to a plurality of corresponding battery cells and measuring a plurality of cell voltages, and a relay turned on when the BMIC operates; a plurality of first resistors located on a wiring extending between both ends of a power source in correspondence to the plurality of slave BMSs; a plurality of second resistors connected between a first end of the relays and the wiring; a third resistor connected between the power source and the plurality of first resistors on the wiring; and a master BMS determining positions and a number of BMICs operating among the plurality of BMICs based on a sensing voltage obtained by dividing a voltage of the power source by at least one of the third resistor, the plurality of first resistors, and the plurality of second resistors.

Each of the plurality of slave BMSs may include a diode including an anode connected to a positive terminal of the battery pack, the diode and the relay constituting a photoMOS relay; and a transistor having a first end connected to the cathode of the diode and a second end connected to the BMIC, the transistor operates under the control of the BMIC to supply power to the BMIC.

Each of the plurality of slave BMSs may further include a capacitor connected in parallel to the diode.

A first end of the third resistor may be connected to the power source, a second end of the third resistor may be connected to to a first end of a first one of the plurality of first resistors, and a first end of a first relay of a first one of the plurality of slave BMSs may be connected to the first end of the first one of the plurality of first resistors.

A second end of the first relay of the first one of the plurality of slave BMSs may be connected to a first end of one of the plurality of second resistors, and a second end of the one of the plurality of second resistors may be connected to the wiring.

A first end of a second one of the plurality of first resistors may be connected to a second end of the first one of the plurality of first resistors, and a first end of a second relay of a second one of the plurality of slave BMSs may be connected to the first end of the second one of the plurality of first resistors.

A second end of the second relay of the second one of the plurality of slave BMSs may be connected to a first end of a second one of the plurality of second resistors, and a second end of the second one of the plurality of second resistors may be connected to the wiring.

The master BMS may store information about voltages obtained by dividing the voltage of the power source according to whether the plurality of relays are on or off, compare the sensing voltage with the information, and determine the positions and the number BMICs operating among the plurality of BMICs.

A battery system according to another feature of the invention includes a third resistor including a first end connected to a first end of a power source; a plurality of first resistors connected in series between a second end of the third resistor and a second end of the power source; a plurality of relays and a plurality of second resistors connected in series between one end of each first resistor and the second end of the power source; a plurality of diodes constituting a photoMOS relay; a plurality of BMICs to which power is supplied when the plurality of diodes are conducted; and a master BMS determining positions and a number of battery monitoring integrated circuits (BMICs) operating among the plurality of BMICs based on a sensing voltage obtained by dividing a voltage of the power source by at least one of the third resistor, the plurality of first resistors, and the plurality of second resistors.

A first end of a first one of the plurality of relays may be connected to a first end of a first one of the plurality of first resistors, and a first end of a first one of the plurality of second resistors may be connected to a second end of the first one of the of the plurality of relays, and a second end of the first one of the plurality of second resistors is connected to the other end of the power source.

A first end of a second one of the plurality of first resistors may be connected to a second end of the first one of the plurality of the first resistors, and a first end of a second one of the plurality of relays may be connected to the first end of the second one of the plurality of first resistors, a second end of the second one of the plurality of relays may be connected to a first end of a second one of the plurality of second resistors, and a second end of the second one of the plurality of second resistors may be connected to the other end of the power source.

The battery system may further include a plurality of capacitors connected in parallel to the plurality of diodes, respectively.

The master BMS may store information about voltages obtained by dividing the voltage of the power source according to the plurality of relays being on or off, compare the sensing voltage with the information, and determine a number and positions of BMICs operating among the plurality of BMICs.

### Advantageous Effects

The present disclosure may provide a battery system capable of diagnosing whether a plurality of BMICs constituting the battery system are normally operated.

### DESCRIPTION OF THE DRAWINGS

FIG. 1 is a diagram illustrating a battery system according to an embodiment.

FIG. 2 is a diagram schematically illustrating the inside of a slave BMS according to an embodiment.

FIG. 3 is a diagram schematically illustrating only the configuration for detecting an operation of a BMIC in a battery system according to an embodiment.

### MODE FOR INVENTION

Hereinafter, the embodiments disclosed in the present specification will be described in detail with reference to the accompanying drawings, but same or similar components are given the same or similar reference numerals, and redundant descriptions thereof will be omitted. The suffixes “module” and/or “part” for components used in the following description are given or mixed in consideration of only the ease of drafting the specification, and do not have meanings or roles distinct from each other by themselves. In addition, in describing the embodiments disclosed in the present specification, when it is determined that detailed descriptions of related known technologies may obscure the gist of the embodiments disclosed in the present specification, the detailed description thereof will be omitted. In addition, the accompanying drawings are only for easy understanding of the embodiments disclosed in the present specification, do not limit the technical idea disclosed in the present specification, and should be understood to include all changes, equivalents or substitutes included in the spirit and scope of the present disclosure.

The terms including an ordinal number, such as first, second, etc., may be used to describe various components, but the components are not limited by the terms. These terms are used only for the purpose of distinguishing one component from another.

It will be further understood that the terms “comprises” and/or “comprising,” when used in the present specification, specify the presence of stated features, integers, steps, operations, components, and/or parts, but do not preclude the presence or addition of one or more other features, integers, steps, operations, components, parts, and/or combinations thereof.

A program implemented as a set of instructions embodying a control algorithm necessary to control another configuration may be installed in a configuration controlling another configuration under a specific control condition among configurations according to an embodiment. The control configuration may process input data and stored data according to the installed program to generate output data. The control configuration may include a non-volatile memory to store a program and a memory to store data.

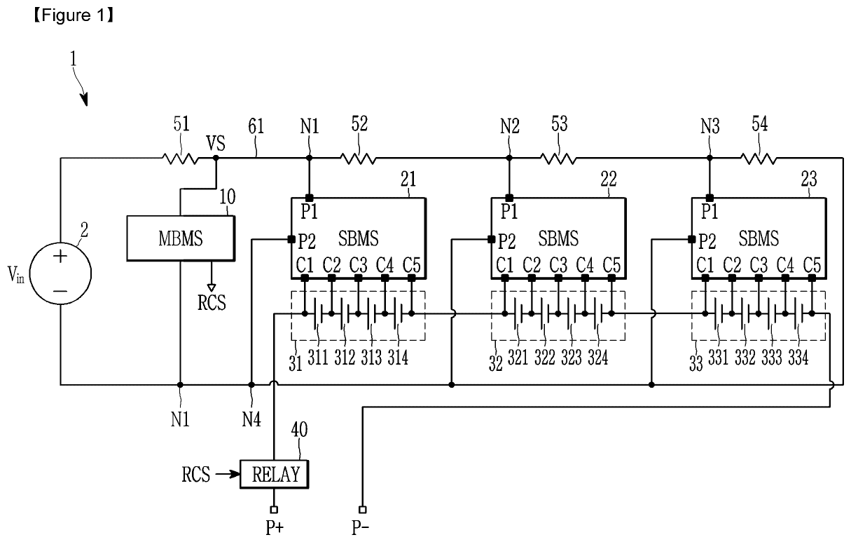

FIG. 1 is a diagram illustrating a battery system according to an embodiment.

As shown in FIG. 1, a battery system 1 includes a master battery management system (MBMS) 10, a plurality of slave battery management systems (SBMS) 21 to 23, a plurality of battery packs 31 to 33, and a relay 40.

As shown in FIG. 1, an input voltage Vin may be supplied from a power source 2 to the battery system 1. The power source 2 may be a commercial power source such as a wall power source, and may be, for example, 24 V. FIG. 1 shows three battery packs 31 to 33 and three slave BMSs 21 to 23, but this is an example and the invention is not limited thereto. According to the output power required of the battery system 1, a plurality of battery packs may be series, parallel, or series-parallel. Output terminals P+ and P− of the battery system 1 may be connected to a load or a charger.

Each of the plurality of battery packs 31 to 33 may include a plurality of battery cells (e.g., 311 to 314, 321-324, 331-334) connected in series. In FIG. 1, each of the plurality of battery packs 31 to 33 is illustrated as including four battery cells 311 to 314, 321-324, 331-334, connected in series, but this is an example and the invention is not limited thereto.

The relay 40 is connected between one electrode (e.g., a positive electrode) with respect to the plurality of battery packs 31 to 33 and the output terminal P+ of the battery system 1, and is switched by the control of the master BMS 10. The master BMS 10 may generate a relay control signal RCS for controlling the opening or closing of the relay 40 and supply the relay control signal RCS to the relay 40. Although only one relay is shown in FIG. 1, a relay may be further connected between the other electrode (e.g., a negative electrode) with respect to the plurality of battery packs 31 to 33 and the output terminal P− of the battery system 1.

Each of the plurality of slave BMSs 21 to 23 is connected to a corresponding battery pack among the plurality of battery packs 31 to 33. For example, the battery pack 31 includes a plurality of battery cells 311 to 314 connected in series, and the slave BMS 21 is connected to both ends of each of the plurality of battery cells 311 to 314 through terminals C1 to C5. The slave BMS 21 may be operated by a voltage supplied from the battery pack 31, measure a cell voltage of each of the plurality of battery cells 311 to 314, measure the current and temperature of the battery pack 31, and control and perform cell balancing on the plurality of battery cells 311 to 314.

In the same way, the battery pack 32 also includes a plurality of battery cells 321 to 324 connected in series and is connected to the slave BMS 22, and the battery pack 33 also includes a plurality of battery cells 331 to 334 connected in series and is connected to the slave BMS 23.

The master BMS 10 may transmit/receive information necessary for managing the battery system 1 through communication with the plurality of slave BMSs 21 to 23. For example, the master BMS 10 may control the output power of the battery system 1 or estimate a state of charge (SOC), a state of health (SOH), a state of power (SOP) of the plurality of battery packs 31 to 33, etc. To this end, the master BMS 10 may receive information about cell voltages, battery currents and temperatures of the plurality of battery packs 31 to 33 from the plurality of slave BMSs 21 to 23.

Although a configuration for communication between the master BMS 10 and the plurality of slave BMSs 21 to 23 is not shown in FIG. 1, it may be seen that information transmission and reception between the master BMS 10 and the plurality of slave BMSs 21 to 23 is possible through various communication methods in the known document and technology (i.e., as known in the art).

The power source 2 and the plurality of slave BMSs 21 to 23 are connected through a wiring 61 extending between both ends of the power source 2. Both ends of the power source 2 include one end of a positive potential and the other end of a negative potential, and a plurality of resistors 51 to 54 are connected in series between one end and the other end of the power source 2.

The plurality of slave BMSs 21 to 23 may transfer information about current consumed by the BMICs of the plurality of slave BMSs 21 to 23 to the master BMS 10 through the wiring 61. The slave BMS 21 is connected to the wiring 61 at a contact point N1 through a terminal P1 and connected to the wiring 61 at a contact point N4 through a terminal P2. The slave BMS 22 is connected to the wiring 61 at a contact point N2 through the terminal P1 and connected to the wiring 61 at a contact point N4 through the terminal P2. The slave BMS 23 is connected to the wiring 61 at the contact point N1 through the terminal P1 and connected to the wiring 61 at the contact point N4 through the terminal P2.

A resistor 51 is connected between the power source 2 and the contact point N1, a resistor 52 is connected between the contact point N1 and the contact point N2, a resistor 53 is connected between the contact point N2 and the contact point N3, and a resistor 54 is connected between the contact point N3 and the contact point N4.

The master BMS 10 may measure the voltage of the contact point N1, and detect an abnormal slave BMS among the plurality of slave BMSs 21 to 23 according to the measured voltage and control conditions with respect to the plurality of battery packs 31 to 33.

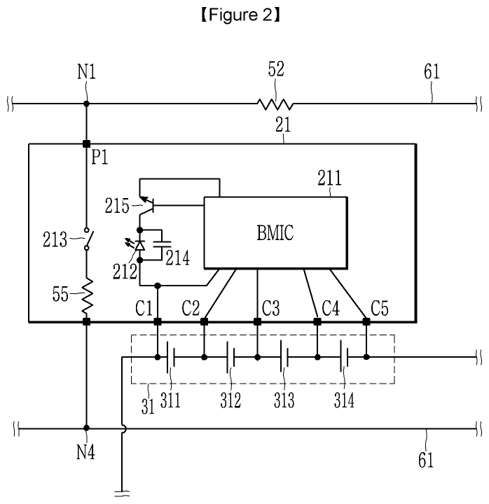

FIG. 2 is a diagram schematically illustrating the inside of a slave BMS according to an embodiment.

Although only the slave BMS 21 is shown in FIG. 2, the slave BMSs 22 and 23 shown in FIG. 1 may also have the same configuration as the slave BMS 21 shown in FIG. 2.

The slave BMS 21 includes a BMIC 211, a diode 212 and a relay 213 constituting a photoMOS relay, a bipolar junction transistor (BJT) 215, and a resistor 55.

In the slave BMS 21, a terminal C1 is connected to a positive electrode of the battery cell 311, a terminal C2 is connected to a negative electrode of the battery cell 311 and a positive electrode of the battery cell 312, a terminal C3 is connected to a negative electrode of the battery cell 312 and a positive electrode of the battery cell 313, a terminal C4 is connected to a negative electrode of the battery cell 313 and a positive electrode of the battery cell 314, and a terminal C5 is connected to a negative electrode of the battery cell 314. The BMIC 211 may measure a cell voltage of a battery cell (e.g., 311) based on a voltage difference between two adjacent terminals (e.g., C1 and C2) among the plurality of terminals C1 to C5.

The BMIC 211 receives power required for driving from the battery pack 31. A control voltage VB is supplied from the BMIC 211 to a base terminal of the BJT 215, and the BJT 215 is conducted by the control voltage VB so that power necessary for driving the BMIC 211 is supplied from the battery pack 31. The base and emitter terminals of the BJT 215 may be connected to the BMIC 211, the control voltage VB may be supplied from the BMIC 211 to the base terminal of the BJT 215, and power from the battery pack 31 may be supplied through the emitter terminal of the BJT 215.

A cathode of the diode 212 is connected to a collector terminal of the BJT 215, and an anode of the diode 212 is connected to a positive electrode of the battery pack 31 through the terminal C1. A capacitor 214 is connected in parallel between both ends of the diode 212, and thus, the voltage of both ends of the diode 212 may be smoothed. Then, the voltage of both ends of the diode 212 may be controlled as a voltage of a continuous waveform rather than a discontinuous transition waveform, such as a pulse.

The relay 213 may be turned on (closed) while the diode 212 emits light and may inform the master BMS 10 that the BMIC 211 is consuming current. One end of the relay 213 is connected to the contact point N1, the other end of the relay 213 is connected to one end of the resistor 55, and the other end of the resistor 55 is connected to the contact point N4. That is, when the BMIC 211 operates and current flows to the BMIC 211, the relay 213 is turned on, and the resistor 55 may be connected between the contact point N1 and the contact point N4.

Each of the slave BMSs 22 and 23 also includes a BMIC, and when the BMIC operates and consumes current, a resistor is connected between the corresponding contact points N2 and N3 and a contact point N4.

Hereinafter, an embodiment in which a voltage VS (hereinafter referred to as a sensing voltage) varies according to whether the BMICs of the plurality of slave BMSs 21 to 23 operate and current flows will be described. The master BMS 10 may measure the sensing voltage VS and derive an operating BMIC among the BMICs of the plurality of slave BMSs 21 to 23.

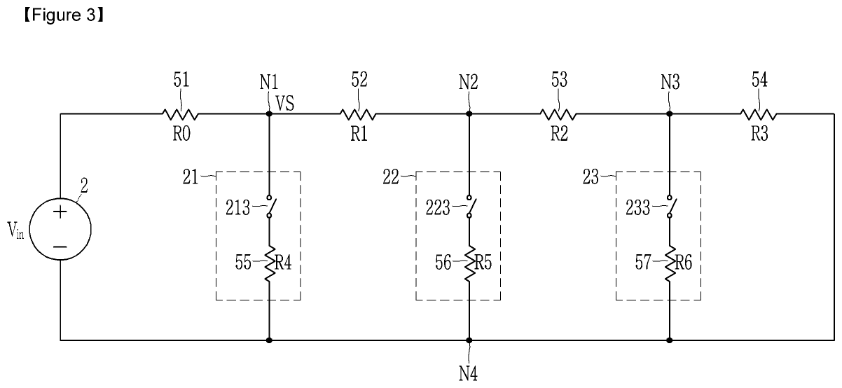

FIG. 3 is a diagram schematically illustrating only the configuration for detecting an operation of a BMIC in a battery system according to an embodiment.

As shown in FIG. 3, in the slave BMS 21, the relay 213 and the resistor 55 are connected in series between the contact point N1 and the contact point N4, in the slave BMS 22, the relay 223 and the resistor 56 are connected in series between the contact point N2 and the contact point N4, and in the slave BMS 23, the relay 233 and the resistor 57 are connected in series between the contact point N3 and the contact point N4. The resistors 56 and 57 and the relays 223 and 233 shown in FIG. 3 are components corresponding to the resistor 55 and the relay 213 of the slave BMS 21 shown in FIG. 2 in the slave BMSs 22 and 23.

A value of the sensing voltage VS may vary according to the position and number of relays that are in an on state (closed) among the plurality of relays 213, 223 and 233.

For example, when all of the plurality of relays 213, 223, and 233 are in an on state (closed), the sensing voltage VS has a value equal to Equation 1 below.

$$V S = V in * [ ( R 4 ∥ ( R 1 + ( R 5 ∥ ( R 2 + ( R 3 ∥ R 4 ) ) ) ) ) / ( R 0 + ( R 4 ∥ ( R 1 + ( R 5 ∥ ( R 2 + ( R 3 ∥ R 4 ) ) ) ) ) ) ] \qquad ( Equation 1 )$$

In Equation 1, R0 to R6 respectively denote resistance values of the resistors 51 to 57, Vin denotes a voltage of a power source, and the symbol “∥” indicates a parallel connection resistance value. The above definition is equally applied to Equations 2 to 8 below.

Among the plurality of relays 213, 223, and 233, when the relay 213 is in an on state and the relays 223 and 233 are in an off state (open), the sensing voltage VS has a value shown in Equation 2 below.

$$V S = V in * [ ( R 4 ∥ ( R 1 + R 2 + R 3 ) ) / ( R 0 + ( R 4 ∥ ( R 1 + R 2 + R 3 ) ) ) ] \qquad ( Equation 2 )$$

Among the plurality of relays 213, 223, and 233, when the relay 223 is in an on state and the relays 213 and 233 are in an off state (open), the sensing voltage VS has a value shown in Equation 3 below.

$$V S = V in ⋆ [ ( R 1 + ( R 5 ∥ ( R 2 + R 3 ) ) ) / ( R 0 + R 1 ( R 5 ∥ ( R 2 + R 3 ) ) ) ] \qquad ( Equation 3 )$$

Among the plurality of relays 213, 223, and 233, when the relay 233 is in an on state and the relays 213 and 223 are in an off state (open), the sensing voltage VS has a value shown in Equation 4 below.

$$V S = V in * [ ( R 1 + R 2 + ( R 3 ∥ R 6 ) ) / ( R 0 + R 1 + R 2 + ( R 3 ∥ R 6 ) ) ] \qquad ( Equation 4 )$$

When the relays 213 and 223 among the plurality of relays 213, 223, and 233 are in an on state and the relay 233 is in an off state (open), the sensing voltage VS has a value shown in Equation 5 below.

$$V S = V in * [ ( R 4 ∥ ( R 1 + ( R 5 ∥ ( R 2 + R 3 ) ) ) / ( R 0 + R 4 ∥ ( R 1 + ( R 5 ∥ ( R 2 + R 3 ) ) ) ) ] \qquad ( Equation 5 )$$

When the relays 213 and 233 among the plurality of relays 213, 223, and 233 are in an on state and the relay 223 is in an off state (open), the sensing voltage VS has a value shown in Equation 6 below.

$$V S = V in * [ ( R 4 ∥ ( R 1 + R 2 + ( R 3 ∥ R 6 ) ) ) / ( R 0 + ( R 4 ∥ ( R 1 + R 2 + ( R 3 ∥ R 6 ) ) ) ) ] \qquad ( Equation 6 )$$

When the relays 223 and 233 among the plurality of relays 213, 223, and 233 are in an on state and the relay 213 is in an off state (open), the sensing voltage VS has a value shown in Equation 7 below.

$$V S = V in * [ ( R 1 + ( R 5 ∥ ( R 2 + ( R 3 ∥ R 4 ) ) ) ) / ( R 0 + R 1 + ( R 5 ∥ ( R 2 + ( R 3 ∥ R 4 ) ) ) ) ] \qquad ( Equation 7 )$$

When all of the plurality of relays 213, 223, and 233 are in an off state (open), the sensing voltage VS has a value shown in Equation 8 below.

$$V S = V in * [ ( R 1 + R 2 + R 3 ) / ( R 0 + R 1 + R 2 + R 3 ) ] \qquad ( Equation 8 )$$

As described above, the sensing voltage VS may have different values depending on the positions and number of relays in an on state among the plurality of relays 213, 223, and 233. Accordingly, the master BMS 10 may measure the sensing voltage VS and determine the positions and number of BMICs operating according to the measured sensing voltage VS. For example, the master BMS 10 may store the values of the sensing voltage VS according to Equations 1 to 8 in a table, compare the measured sensing voltage VS with the values stored in the table, and determine the positions and number of BMICs operating among the BMICs of the plurality of slave BMSs 21 to 23 according to a comparison result. At this time, the master BMS 10 may set a plurality of corresponding resistance ranges with respect to the values stored in the table, and determine the positions and number of BMICs operating among the BMICs of the plurality of slave BMSs 21 to 23 according to the resistance range to which the measured sensing voltage VS belongs.

Through an embodiment, the master BMS 10 may check whether the BMIC is in a wake state or leakage current flows in the BMIC due to malfunction, noise, or burnout, even when the BMIC is in a sleep state in which the BMIC is not operating.

In FIGS. 1 and 2, the resistors 55, 56, and 57 are illustrated as being respectively located inside the slave BMSs 21, 22, and 23, but the invention is not limited thereto. For example, the resistors 55, 56, and 57 may be respectively connected between the terminal P2 and the contact point N4 of the slave BMSs 21, 22, and 23.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

1. A battery system comprising:
a plurality of battery packs, each of the plurality of battery packs including a plurality of battery cells;
a plurality of slave battery management systems (BMSs), each slave BMS managing a respective one of the plurality of battery packs and including:
a battery monitoring integrated circuit (BMIC) connected to a plurality of corresponding battery cells and measuring a plurality of cell voltages; and
a relay turned on when the BMIC operates;
a plurality of first resistors located on a wiring extending between both ends of a power source in correspondence to the plurality of slave BMSs;
a plurality of second resistors connected between a first end of the relays and the wiring;
a third resistor connected between the power source and the plurality of first resistors on the wiring; and
a master BMS determining positions and a number of BMICs operating among the plurality of BMICs based on a sensing voltage obtained by dividing a voltage of the power source by at least one of the third resistor, the plurality of first resistors, and the plurality of second resistors.

2. The battery system of claim 1,
wherein each of the plurality of slave BMSs includes:
a diode including an anode connected to a positive terminal of the battery pack, the diode and the relay constituting a photoMOS relay; and
a transistor having a first end connected to a cathode of the diode and a second end connected to the BMIC, the transistor operating under the control of the BMIC to supply power to the BMIC.

3. The battery system of claim 2,
wherein each of the plurality of slave BMSs further includes a capacitor connected in parallel to the diode.

4. The battery system of claim 1, wherein:
a first end of the third resistor is connected to the power source,
a second end of the third resistor is connected to a first end of a first one of the plurality of first resistors, and
a first end of a first relay of a first one of the plurality of slave BMSs is connected to the first end of the first one of the plurality of first resistors.

5. The battery system of claim 4, wherein:
a second end of the first relay of the first one of the plurality of slave BMSs is connected to a first end of one of the plurality of second resistors, and a second end of the one of the plurality of second resistors is connected to the wiring.

6. The battery system of claim 4, wherein:
a first end of a second one of the plurality of first resistors is connected to a second end of the first one of the plurality of first resistors, and
a first end of a second relay of a second one of the plurality of slave BMSs is connected to the first end of the second one of the plurality of first resistors.

7. The battery system of claim 6, wherein:
a second end of the second relay of the second one of the plurality of slave BMSs is connected to a first end of a second one of the plurality of second resistors, and a second end of the second one of the plurality of second resistors is connected to the wiring.

8. The battery system of claim 1, wherein:
the master BMS stores information about voltages obtained by dividing the voltage of the power source according to whether the plurality of relays are on or off, compares the sensing voltage with the information, and determines the positions and the number of BMICs operating among the plurality of BMICs.

9. A battery system comprising:
a third resistor including a first end connected to a first end of a power source;
a plurality of first resistors connected in series between a second end of the third resistor and a second end of the power source;
a plurality of relays and a plurality of second resistors connected in series between one end of each first resistor and the second end of the power source;
a plurality of diodes constituting a photoMOS relay;
a plurality of battery monitoring integrated circuits (BMICs) to which power is supplied when the plurality of diodes are conducted; and
a master battery management system (BMS) configured to determine positions and a number of BMICs operating among the plurality of BMICs based on a sensing voltage obtained by dividing a voltage of the power source by at least one of the third resistor, the plurality of first resistors, and the plurality of second resistors.

10. The battery system of claim 9, wherein:
a first end of a first one of the plurality of relays is connected to a first end of a first one of the plurality of first resistors, and
a first end of a first one of the plurality of second resistors is connected to a second end of the first one of the of the plurality of relays, and a second end of the first one of the plurality of second resistors is connected to the other end of the power source.

11. The battery system of claim 10, wherein:
a first end of a second one of the plurality of first resistors is connected to a second end of the first one of the plurality of the first resistors, and
a first end of a second one of the plurality of relays is connected to the first end of the second one of the plurality of first resistors, a second end of the second one of the plurality of relays is connected to a first end of a second one of the plurality of second resistors, and a second end of the second one of the plurality of second resistors is connected to the other end of the power source.

12. The battery system of claim 9, further comprising:
a plurality of capacitors connected in parallel to the plurality of diodes, respectively.

13. The battery system of claim 9, wherein:
the master BMS, stores information about voltages obtained by dividing the voltage of the power source according to the plurality of relays being on or off, compares the sensing voltage with the information, and determines the positions and the number of BMICs operating among the plurality of BMICs.
